(19) United States
(12) Patent Application Publication
(10) Pub. No.: US 2022/0134408 A1
(43) Pub. Date: May 5, 2022

(54) MANUFACTURING METHOD AND MANUFACTURING DEVICE OF ELEMENT

(71) Applicants: AISIN CORPORATION, Kariya, Aichi (JP); MI Seiko Co.,Ltd, Soka-shi, Saitama (JP)

(72) Inventors: Yasuhiro TAKEUCHI, Kariya-shi, Aichi-ken (JP); Toru ASAMI, Kariya-shi, Aichi-ken (JP); Kazuhisa MIYATA, Setagaya-ku,Tokyo (JP); Hirotaka HATA, Kawaguchi-shi, Saitama-ken (JP); Masayuki OKANO, Sumida City (JP)

(73) Assignees: AISIN CORPORATION, Kariya, Aichi (JP); MI Seiko Co.,Ltd, Soka-shi, Saitama (JP)

(21) Appl. No.: 17/431,795

(22) PCT Filed: Mar. 26, 2020
(86) PCT No.: PCT/JP2020/013553

§ 371 Date: Aug. 18, 2021

(30) Foreign Application Priority Data
Mar. 29, 2019 (JP) 2019-067572

(51) Int. Cl. B21D 28/26

(52) U.S. Cl. CPC B21D 28/26

(57) ABSTRACT

An element manufacturing method for a transmission belt of a continuously variable transmission having a thick wall portion and a thin wall portion formed by sequentially feeding a material having a strip shape with a uniform thickness to each press position and performing press working on the material at the press position. The method includes, as the press working performed at the press position: a preliminary punching step in which a portion other than a connecting portion is cut off from surrounding material and the cut off portion is punched so as not to overlap with the surrounding material in a plate thickness direction; a crushing step of compressing and crushing a region of the thin walled cut off portion, after the preliminary punching step; and a punching step of punching the cutting off portion into an outer shape corresponding to the element, after the crushing step.

### CROSS REFERENCE TO RELATED APPLICATIONS

This application is a National Stage of International Application No. PCT/JP2020/013553 filed Mar. 26, 2019, claiming priority based on Japanese Patent Application No. 2019-067572 filed Mar. 29, 2019, the contents of which are incorporated by reference in their entirety.

### TECHNICAL FIELD

The present description discloses a manufacturing method and a manufacturing device of an element.

### BACKGROUND ART

Conventionally, as this type of element manufacturing method, a manufacturing method in which an element configured of: a body portion having left and right side surfaces that are in contact with a pulley of a continuously variable transmission and having a tapered portion that tapers downward (or a parallel thin wall portion extending downward); a neck portion extending upward from the body portion; and a triangular head portion extending upward from the neck portion, is manufactured from a strip-shaped material having a uniform thickness by performing punch working is proposed (for example, refer to Patent Document 1). In the element manufacturing method, a pair of adjacent elements is punched out so that the head portions face each other with respect to the strip-shaped material. As steps in this manufacturing method, a punching process that punches a material so that a line drawn by adding excess thickness to a contour of left and right sides of a body portion and a line drawn by adding excess thickness to a contour of a lower side of the body portion are punching lines, a slit forming process of punching and forming a substantially rectangular shaped slit between a pair of head portions facing each other, a plastic working process (crushing process) in which a pair of tapered portions is formed on the material by performing plastic working on the material so that the plate thickness is reduced, and a second punching process for punching the element as a product from a strip-shaped material are provided.

### RELATED ART DOCUMENTS

### Patent Documents

Patent Document 1: WO2010/125876

### SUMMARY OF THE DISCLOSURE

### Problem to be Solved by the Various Aspects of the Disclosure

However, in the above-mentioned element manufacturing method, in order to secure the flow destination of the material when reducing the plate thickness of the material and forming the tapered portion in the body portion, a large slit needs to be formed in the surroundings of the body portion in advance with a punching step or a slit forming step. Thus, there is a problem that the material is wasted by just an amount of the size of the slit and the product yield is deteriorated.

It is an aspect of the element manufacturing method and the element manufacturing device of the present disclosure is to improve product yield while accurately molding the thin wall portion when an element having a thick wall portion and a thin portion is molded from a strip plate shaped material having a uniform thickness by performing punching work.

### Means for Solving the Problem

The element manufacturing method and the manufacturing device of the present disclosure have adopted the following means in order to achieve the above-mentioned aspects.

An outline of the element manufacturing method of the present disclosure is that the element manufacturing method is an element manufacturing method for manufacturing an element that constitutes a transmission belt wound between a pair of pulleys of a continuously variable transmission and that has a thick wall portion and a thin wall portion, by sequentially feeding a material having a strip shape with a uniform thickness to each press position and performing press working on the material at the press position, in which as the press working performed at the press position, the element manufacturing method includes: a preliminary punching step in which a cutting off portion other than a connecting portion is cut off from a surrounding material while the connecting portion connected to the surrounding material is left, and the cutting off portion is punched so as not to overlap with the surrounding material in a plate thickness direction; a crushing step of compressing and crushing a region of the cutting off portion which corresponds to the thin wall portion, after the preliminary punching step; and a punching step of punching the cutting off portion into an outer shape corresponding to the element, after the crushing step.

The element manufacturing method of the present disclosure manufactures an element that constitutes a transmission belt of a continuously variable transmission and that has a thick wall portion and a thin wall portion, by sequentially feeding a material having a strip shape with a uniform thickness to each press position and performing press working on the material at the press position. As the press working performed at the press position, the element manufacturing method includes: a preliminary punching step in which a cutting off portion other than a connecting portion is cut off from a surrounding material while the connecting portion connected to a surrounding material is left, and the cutting off portion is punched so as not to overlap with the surrounding material in a plate thickness direction; a crushing step of compressing and crushing a region of the cutting off portion which corresponds to the thin wall portion, after the preliminary punching step; and a punching step of punching the cutting off portion into an outer shape corresponding to the element, after the crushing step. In this way, since the cutting off portion is punched out so as not to overlap with the surrounding material in the plate thickness direction, and then the cutting off portion is compressed and crushed, the compressed material can smoothly flow in a plane direction. As a result, when the element is molded, the thin wall portion can be formed with high accuracy. In addition, this makes it possible to eliminate the need to form slits around the material in advance in order to secure the flow destination of the material in the crushing process, and to make the required slits smaller. Thus, the element can be taken out more efficiently from the material and the product yield can be improved. As a result, when the element having the thick wall portion and the thin wall portion is molded from the strip plate shaped material having a uniform thickness by performing punching work, the product yield can be improved while accurately molding the thin wall portion. When a pilot hole forming step in which a pilot hole for positioning the material in the subsequent step is formed in the material is provided before the preliminary punching step, since the cutting off portion and the surrounding material are displaced in the plate thickness direction, it is possible to suppress the material compressed by the crushing process from flowing toward the pilot hole to cause an adverse effect on the pilot hole.

An outline of the element manufacturing device of the present disclosure is that the element manufacturing device is an element manufacturing device for manufacturing an element that constitutes a transmission belt of a continuously variable transmission and that has a thick wall portion and a thin wall portion, by sequentially feeding a material having a strip shape with a uniform thickness to each press position and performing press working on the material at the press position, the element manufacturing device including: a preliminary punching die that is provided at a first press position and that performs preliminary punching in which a cutting off portion other than a connecting portion is cut off from a surrounding material while the connecting portion connected to the surrounding material is left, and the cutting off portion is punched so as not to overlap with the surrounding material in a plate thickness direction; a crushing die that is provided at a second press position downstream of the first press position in a feeding direction and that performs crushing work in which a region of the cutting off portion which corresponds to the thin wall portion is compressed; and a punching die that is provided at a third press position downstream of the second press position in the feeding direction and that performs punching work in which the cutting off portion is punched into an outer shape corresponding to the element.

The element manufacturing device of the present disclosure is provided with the dies (the preliminary punching die, the crushing die, and the punching die) for performing press working to realize each step of the above-described element manufacturing method of the present disclosure. Thus, an effect similar to the effect delivered by the element manufacturing method of the present disclosure can be delivered by the element manufacturing device. That is, when an element having a thick wall portion and a thin wall portion is molded from a strip plate shaped material having a uniform thickness by performing punching work, an effect of improving product yield while accurately molding the thin wall portion can be delivered.

### BRIEF DESCRIPTION OF THE DRAWINGS

FIG. 1 is a schematic configuration view of a continuously variable transmission having a transmission belt.

FIG. 2 is a schematic configuration view of the transmission belt.

FIG. 3 is a schematic configuration view of an element manufacturing device.

FIG. 4 is an explanatory view showing an element manufacturing process.

FIG. 5 is a schematic configuration view of a preliminary punching die.

FIG. 6 is a schematic configuration view of the preliminary punching die.

FIG. 7 is an external perspective view of a strip plate material after preliminary punching.

FIG. 8 is a cross-sectional view of the strip plate material after preliminary punching.

FIG. 9 is a side view of the strip plate material after preliminary punching.

FIG. 10 is a rear view of the strip plate material after preliminary punching.

FIG. 11 is a front view of the strip plate material after preliminary punching.

FIG. 12 is a schematic configuration view of a step-crushing molding die.

FIG. 13 is an external perspective view of the strip plate material after step-crushing molding.

FIG. 14 is a side view of the strip plate material after step-crushing molding.

FIG. 15 is an explanatory view showing a state in which a material flows by step-crushing molding.

FIG. 16 is a schematic configuration view of a plate thickness-crushing molding die.

FIG. 17 is an external perspective view of the strip plate material after plate thickness-crushing molding.

FIG. 18 is a side view of the strip plate material after the plate thickness-crushing molding.

FIG. 19 is a schematic configuration view of an emboss molding die.

FIG. 20 is an external perspective view of the strip plate material after emboss molding.

FIG. 21 is a side view of the strip plate material after emboss molding.

FIG. 22 is a schematic configuration view of a half-punching die.

FIG. 23 is an external perspective view of the strip plate material after half-punching.

FIG. 24 is a side view of the strip plate material after half-punching.

FIG. 25 is a schematic configuration view of a punching out die.

FIG. 26 is a schematic configuration view of a transmission belt including an element of another embodiment.

FIG. 27 is an explanatory diagram showing an element manufacturing process of another embodiment.

### DESCRIPTION OF EMBODIMENTS

Next, modes for carrying out the present disclosure will be described with reference to the drawings.

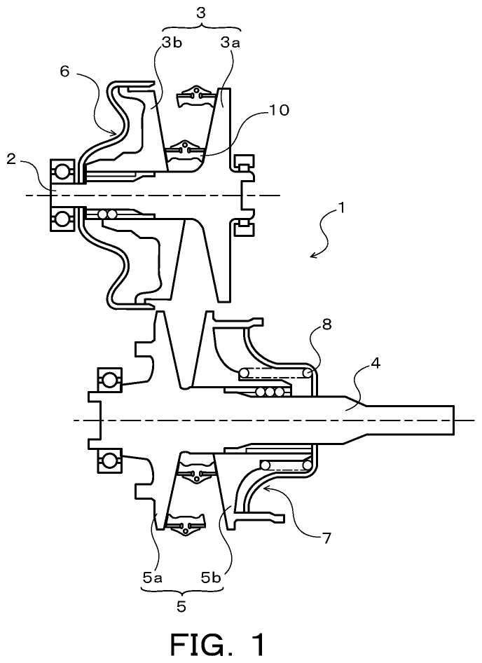

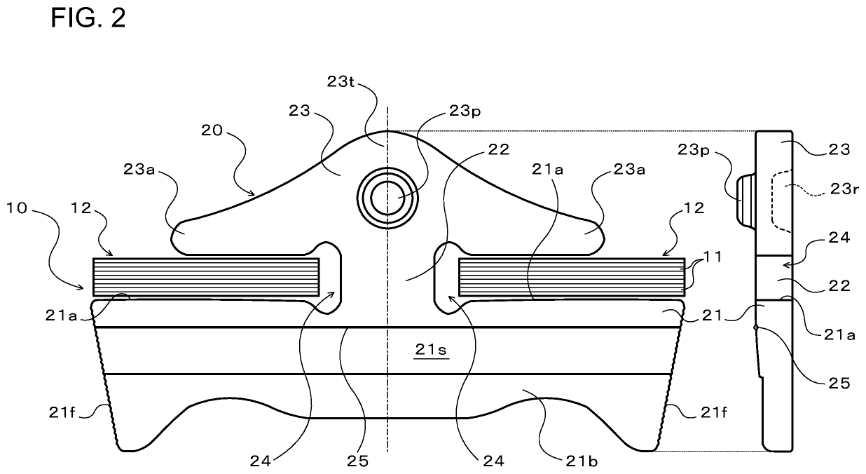

FIG. 1 is a schematic configuration view of a continuously variable transmission having a transmission belt, and FIG. 2 is a schematic configuration view of the transmission belt. As shown in FIG. 1, a continuously variable transmission 1 has a primary shaft 2 serving as a drive side rotation shaft, a primary pulley 3 provided on the primary shaft 2, a secondary shaft 4 serving as a driven side rotation shaft disposed in parallel with the primary shaft 2, and a secondary pulley 5 provided on the secondary shaft 4. A transmission belt 10 is wound around a pulley groove (V-shaped groove) of the primary pulley 3 and a pulley groove (V-shaped groove) of the secondary pulley 5.

The primary shaft 2 is coupled to an input shaft, which is not shown, coupled to a power generation source such as an engine (internal combustion engine) via a forward/backward switching mechanism, which is not shown. The primary pulley 3 has a fixed sheave 3a formed integrally with the primary shaft 2 and a movable sheave 3b supported by the primary shaft 2 via a ball spline or the like so that the movable sheave 3b is slidable in an axial direction. The secondary pulley 5 has a fixed sheave 5a formed integrally with the secondary shaft 4, and a movable sheave 5b that is supported by the secondary shaft 4 via a ball spline or the like so that the movable sheave 5b is slidable in an axial direction, and that is also urged in the axial direction by a return spring 8.

Further, the continuously variable transmission 1 includes a primary cylinder 6 that is a hydraulic actuator for changing a groove width of the primary pulley 3, and a secondary cylinder 7 that is a hydraulic actuator for changing a groove width of the secondary pulley 5. The primary cylinder 6 is formed behind the movable sheave 3b of the primary pulley 3, and the secondary cylinder 7 is formed behind the movable sheave 5b of the secondary pulley 5. Working oil is supplied to the primary cylinder 6 and the secondary cylinder 7 from a hydraulic control device, which is not shown, in order to change the groove widths of the primary pulley 3 and the secondary pulley 5. Thus, it is possible to shift a torque that is transmitted from the engine and the like to the primary shaft 2 via the input shaft and the forward/backward switching mechanism in a stepless manner and output the torque to the secondary shaft 4. The torque output to the secondary shaft 4 is transmitted to drive wheels of a vehicle via a gear mechanism, a differential gear, and a drive shaft (all not shown).

As shown in FIG. 2, the transmission belt 10 includes two stacked rings 12 configured by stacking a plurality of (in the present embodiment, nine for example) elastically deformable ring materials 11 in a thickness direction (ring radial direction), and a plurality of (for example, several hundred) elements 20 arranged (bound) in an annular shape along an inner peripheral surface of the stacked rings 12. Each of the plurality of ring materials 11 that configure the stacked rings 12 is elastically deformable and is cut out from a steel plate drum, and is processed so as to have substantially the same thickness and different peripheral lengths determined in advance for each ring material 11. Further, each ring material 11 is gently curved so that a central portion in the axial direction protrudes slightly to the outer radial side.

Each element 20 is punched by press working from a metal strip plate-shaped material (strip plate material) 50 having a uniform plate thickness. As shown in FIG. 2, each element 20 has a body portion 21 extending horizontally in the drawing, a neck portion 22 extended from a central portion of the body portion 21 in the width direction to an outer peripheral side of the transmission belt 10 (an outer side in the radial direction of the transmission belt 10 and the stacked ring 12), and a head portion 23 including a pair of ear portions 23a extended from the neck portion 22 to both sides of the body portion 21 in the width direction so as to be spaced away from the body portion 21. The width of the body portion 21 is the same as or larger than the width of the head portion 23, and two ring housing portions (recessed portions) 24 are defined by the body portion 21, the neck portion 22, and each ear portion 23a of the head portion 23. Further, one protrusion (dimple) 23p is formed in the central portion in the width direction of a front surface (one surface) of the head portion 23, and a recess 23r is formed on a back surface (the other surface) of the head portion 23 so as to be positioned on the back side of the protrusion 23p.

The stacked rings 12 are fitted into the ring housing portions 24 of each element 20 so as to sandwich the element 20 from both sides, and the protrusion 23p of each element 20 is loosely fitted into the recess 23r of the adjacent element 20. As a result, a large number of elements 20 are bundled by the two stacked rings 12 in a state of being arranged in an annular shape. Further, a surface of the body portion 21 (upper surface in FIG. 2) that defines the ring housing portion 24 is a saddle surface 21a that is in contact with the inner peripheral surface of the stacked ring 12 (innermost layer ring material 11). That is, the saddle surface 21a is positioned on both sides of the neck portion 22 in the width direction.

Each saddle surface 21a is a convex curved surface curved toward the stacked ring 12. That is, each saddle surface 21a has a symmetrical convex curved surface shape (crowning shape) that is gently inclined downward in the figure toward the outside in the width direction and the neck portion 22 side from a top portion that is the vicinity of the central portion in the width direction. As a result, the stacked ring 12 can be centered by applying a centripetal force to the stacked ring 12 toward the top portion T by friction with the saddle surface 21a. However, the saddle surface 21a may include a plurality of convex curved surfaces that are curved outward in the radial direction of the transmission belt 10, etc. Further, a radius of curvature of the saddle surface 21a (convex curved surface) is set to be smaller than a radius of curvature of the curvature of the innermost layer ring material 11 (stacked ring 12) along the axial direction.

Further, the body portion 21 of each element 20 has a pair of side surfaces 21f formed so as to be spaced away from each other, from the inner peripheral side to the outer peripheral side (outer side in the radial direction of the transmission belt or the like) of the transmission belt 10. Each side surface 21f serves as a torque transmitting surface (frank surface) that is in frictional contact with the surface of the pulley groove of the primary pulley 3 or the pulley groove of the secondary pulley 5 to receive a clamping pressure from the pulleys 3 and 5 and transmits a torque from the primary pulley 3 to the secondary pulley 5 by the frictional force. In the present embodiment, as illustrated, recesses and protrusions (a plurality of grooves) for holding working oil for lubricating and cooling a contact portion of each element 20 with the primary pulley 3 or the secondary pulley 5 are formed on the surface of each side surface 21f.

Further, as shown in FIG. 2, the front surface (the surface on the protrusion 23p side) of the element 20 of the present embodiment includes an inclined surface 21s, and the back surface thereof is formed flat. That is, a part of the outer peripheral side of the body portion 21 (the outer side in the radial direction of the transmission belt 10, etc.), the neck portion 22, and the head portion 23 have a substantially constant thickness, and the inclined surface 21s is formed on the body portion 21, in which the inclined surface 21s approaches the back surface as extending from a position more toward the inner peripheral side (the inner side in the radial direction of the transmission belt 10, etc.) than the saddle surface 21a, further toward the inner peripheral side. Further, a step portion 21b that is thinner than a part including the inclined surface 21s of the body portion 21 and that has a substantially constant thickness is formed on the inner peripheral portion (lower end portion in FIG. 2) of the body portion 21. A boundary part between a flat portion, which includes the neck portion 22 and the head portion 23, and the inclined surface 21s forms a rocking edge 25 that brings the elements 20 adjacent in a traveling direction of the transmission belt 10 into contact with each other and that serves as a fulcrum of rotation of the elements 20. That is, in each element 20, the rocking edge 25 is positioned on the inner peripheral side of each saddle surface 21a.

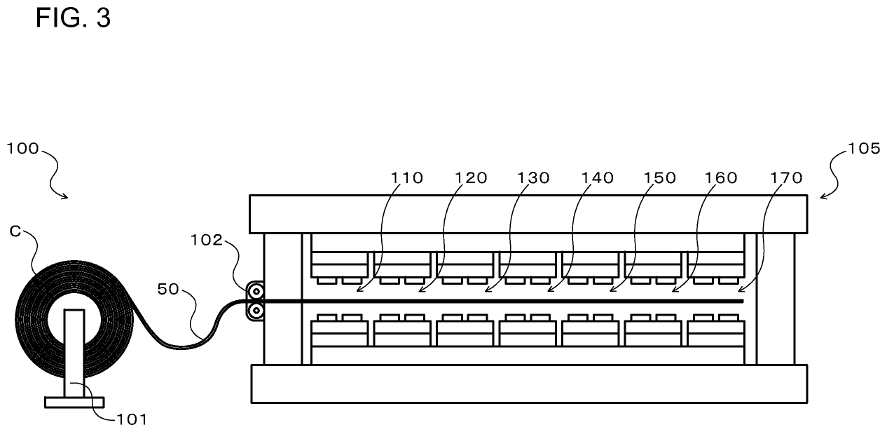

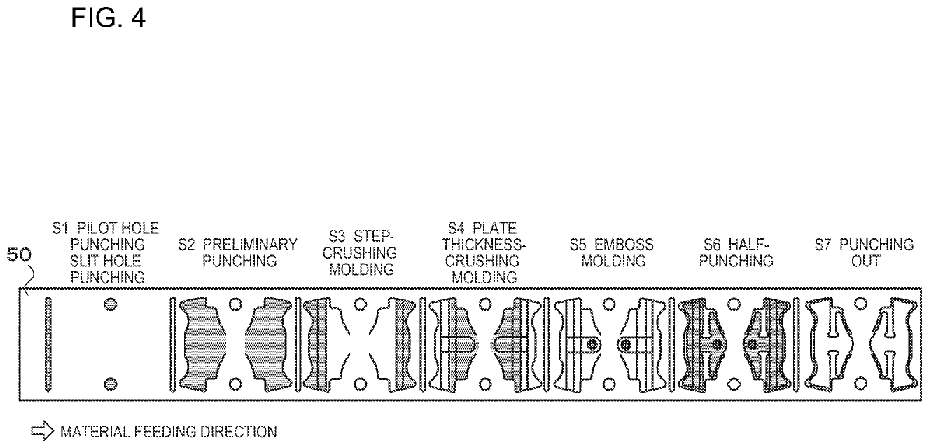

Next, the manufacturing process of the element 20 configured as above will be described. FIG. 3 is a schematic configuration view of an element manufacturing device, and FIG. 4 is an explanatory view showing an element manufacturing process. As shown in FIG. 3, an element manufacturing device 100 has an uncoiler 101 that unwinds a coil material C made by winding the strip plate material 50, a feeding device 102 that feeds the strip plate material 50 that is unwound by the uncoiler 101 in the longitudinal direction, and a press working machine 105 that punches out the strip plate material 50 fed by the feeding device 102 to form the element 20. Manufacture of the element 20 is performed by successively feeding the strip plate material 50 to each press position of the press working machine 105 along the longitudinal direction thereof with the feeding device 102, and press working the strip plate material 50 with the press working machine 105 at each press position. The press working step performed at each press position includes a pilot hole punching and slit hole punching step (S1), a preliminary punching step (S2), a step-crushing molding step (S3), a plate thickness-crushing molding step (S4), an emboss molding step (S5), a half-punching step (S6), and a punching out step (S7). The press working machine 105 includes a pilot hole punching and slit hole punching die 110 used in the pilot hole punching and slit hole punching step (S1), a preliminary punching die 120 used in the preliminary punching step (S2), a step-crushing molding die 130 used in the step-crushing molding step (S3), a plate thickness-crushing molding die 140 used in the plate thickness-crushing molding step (S4), an emboss molding die 150 used in the emboss molding step (S5), a half-punching die 160 used in the half-punching step (S6), and a punching out die 170 used in the punching out step (S7). As shown in FIG. 4, this press working machine 105 performs press working so that a pair of two elements 20 is formed in a state in which the top portions 23t of the head portions 23 (end portions on the opposite side of the head portion 23 from the body portion 21 side) face each other in the longitudinal direction of the strip plate material 50.

The pilot hole punching and slit hole punching step (S1) is a process in which the pilot hole punching and slit hole punching die 110 is used to form two circular pilot holes 50p and one oval shape slit hole 50s in the strip plate material 50. The two pilot holes 50p are used for positioning the strip plate material 50 in press working (for example, an emboss molding step) that is the subsequent step. The two pilot holes 50p are formed on a straight line and at positions that are spaced away from a central portion in a width direction of the body portion 21 at equal distances. Here, the straight line passes through the center between the top portions 23t of the head portions 23 of the pair of two elements 20 to be formed, in which the top portions face each other, and the straight line is parallel to the width direction of the body portion 21 (width direction of the strip plate material 50). Further, the slit hole 50s is used to secure a flow destination of the material when press working is performed in the preliminary punching step that is the subsequent step. The slit hole 50s is formed at a position spaced away from positions, which correspond to the inner peripheral portions of the body portions 21 of the pair of two elements 20 to be formed, at a prescribed distance in the longitudinal direction of the strip plate material 50, and is formed so as to be extended in the width direction of the strip plate material 50.

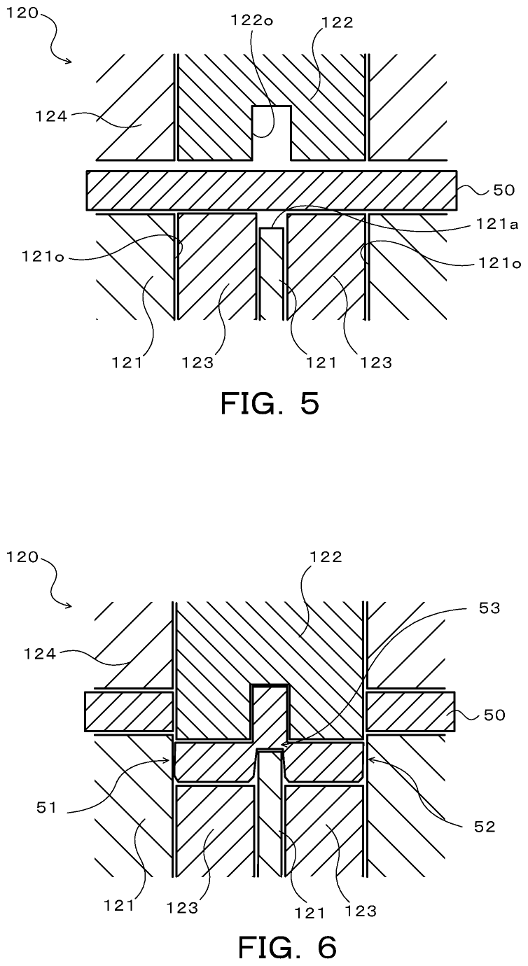

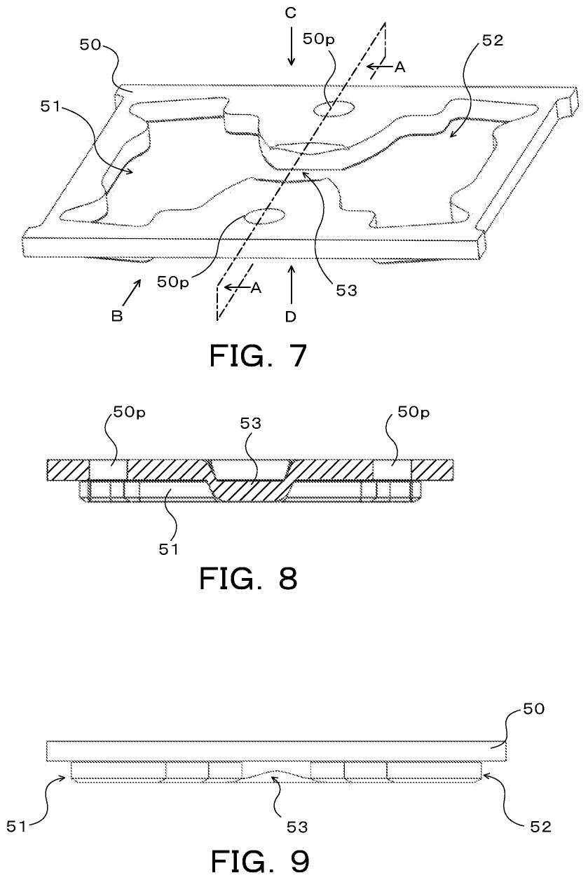

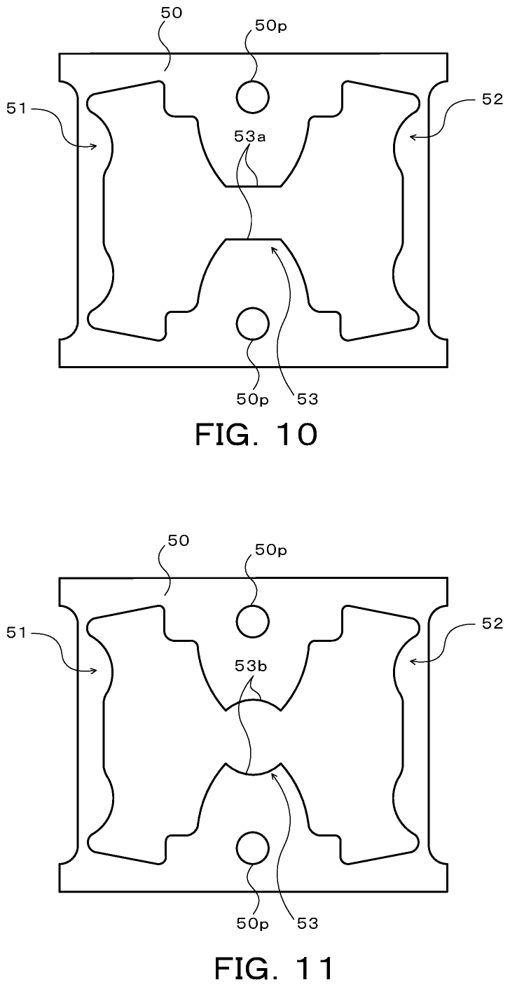

The preliminary punching step (S2) is a step of using the preliminary punching die 120 to leave a position corresponding to a position between the top portions 23t of the head portions 23 of the pair of two elements 20, in the surrounding strip plate material 50 as a connecting portion 53, and is a step of performing punching so that a region including the pair of two elements 20 and excluding the connecting portion 53 is cut off from the surrounding strip plate material 50 as cutting off portions 51 and 52. FIG. 5 and FIG. 6 are schematic configuration views of the preliminary punching die. FIG. 7 is an external perspective view of the strip plate material after preliminary punching. FIG. 8 is a cross-sectional view taken along line A-A of the strip plate material in FIG. 7. FIG. 9 is a side view of the strip plate material in FIG. 7 as viewed in a B direction. FIG. 10 is a rear view of the strip plate material in FIG. 7 as viewed in a C direction. FIG. 11 is a front view of the strip plate material in FIG. 7 as viewed in a D direction. As shown in FIGS. 5 and 6, the preliminary punching die 120 includes a die 121 having two opening portions 121o, a punch 122 that presses the strip plate material 50 from the back surface (the surface that is the back surface side of the element 20, that is, the upper surface in the drawing) side and presses the strip plate material 50 against the two opening portions 1210 of the die 121, two knockouts 123 that are disposed inside the two opening portions 1210 of the die 121 so as to face the punch 122 and that are in contact with the front surface of the strip plate material 50 (the surface on the front surface side of the element 20, that is, the lower surface in the drawing), and a stripper 124 that is disposed around the punch 122 so as to face the die 121 and that holds down the strip plate material 50.

The two opening portions 1210 of the die 121 are formed so that the strip plate material 50 is punched with a line in which an excess thickness portion is added to an outline of contour line of the pair of two elements 20, which is in a state in which the top portions 23t of the head portions 23 face each other, serving as a punching line. As shown in FIGS. 5 and 6, the die 121 has a step portion 121a that is formed so as to form a partition wall of the two opening portions 1210 and also face a recessed portion 122o formed on the surface (lower surface in the drawing) of the punch 122, and that has a surface that is one step lower than the surrounding surface. The step portion 121a is configured as a half-punching portion in which the connecting portion 53 is half-punched so as to be connected to the surrounding strip plate material 50 in the end portion in the plate thickness direction.

With the preliminary punching die 120 configured in this way, as shown in FIGS. 6 to 9, the cutting off portions 51 and 52 are cut off so that the front surface (the surface on the front surface side of the element 20, that is, the lower surface in the drawing) side is spaced farther away from the surrounding strip plate material 50 than the back surface (the surface on the back surface side of the element 20, that is, the lower surface in the drawing) side in the plate thickness direction, and so as not to overlap in the plate thickness direction. The connecting portion 53 is connected to the surrounding strip plate material 50 in the end portion in the plate thickness direction by half-punching, and a step is generated in the plate thickness direction with respect to the surrounding strip plate material 50. As shown in FIG. 10, this step is molded so that a ridge line 53a that has a straight line shape parallel to the longitudinal direction of the strip plate material 50 is formed on the surface on the punch 122 side (the back surface side of the cutting off portions 51 and 52), and as shown in FIG. 11, this step is molded so that a ridge line 53b that has an arc shape (convex curved surface) bulging outward in the width direction (short side direction) of the strip plate material 50 is formed on the surface on the die 121 side (the front surface side of the cutting off portions 51 and 52). As a result, a range of the cutting off portions 51 and 52 can be widened while sufficiently ensuring the strength of the connecting portion 53 (the coupling strength with the surrounding strip plate material 50).

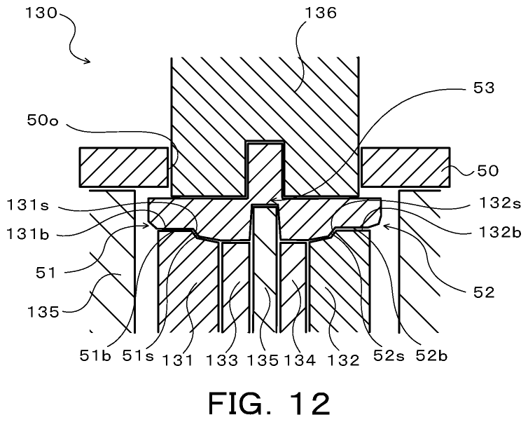

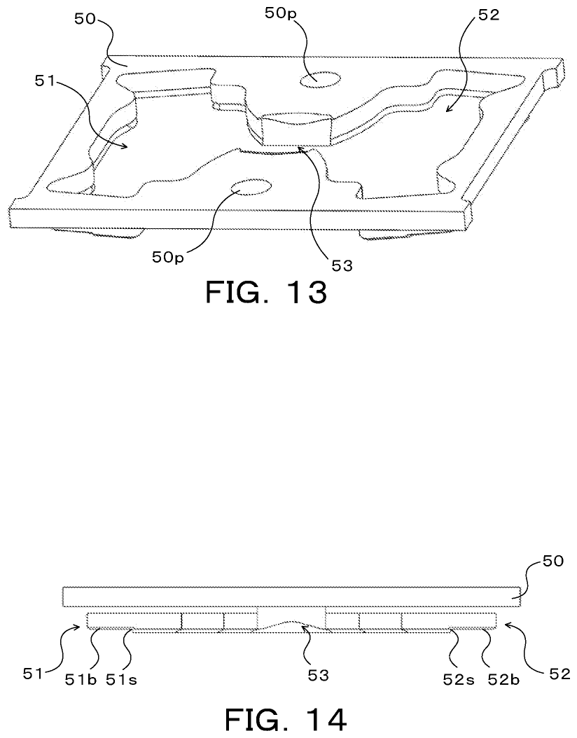

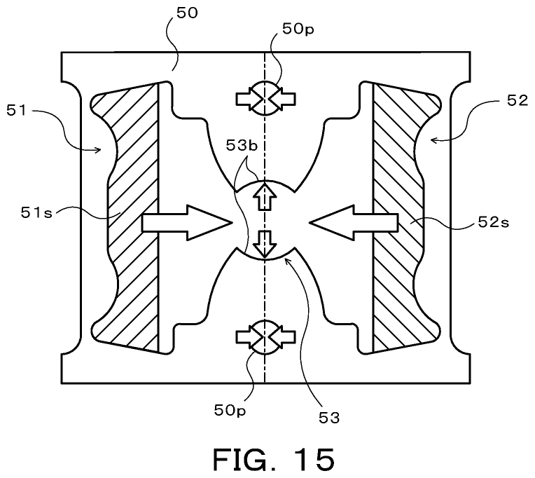

The step-crushing molding step (S3) is a step of using the step-crushing molding die 130 to compress a region on the front surface side of the cutting off portions 51 and 52 which corresponds to the inclined surface 21s and the step portion 21b of the body portion 21 of the element 20, and crushing the region in the plate thickness direction. FIG. 12 is a schematic configuration view of the step-crushing molding die. FIG. 13 is an external perspective view of the strip plate material after step-crushing molding. FIG. 14 is a side view of the strip plate material after step-crushing molding. As shown in FIG. 12, the step-crushing molding die 130 has knockouts 131 to 134 that press the front surfaces of the cutting off portions 51 and 52 (the surfaces on the front surface side of the element 20), a knockout holder 135 that is disposed around the knockouts 131 to 134 and that holds the knockouts 131 to 134, and a pressing punch 136 that is disposed so as to face the knockouts 131 to 134 and that presses the back surfaces of the cutting off portions 51 and 52 (the surfaces on the back surface side of the element 20).

The knockouts 131 and 132 are disposed on the front surface side of the cutting off portions 51 and 52 and formed with an outer shape larger than the opening portion 50o of the strip plate material 50 that is formed by performing cutting off, and the knockouts 131 and 132 each have a contact surface (pressing surface) that is in contact with a region on the front surface side of the cutting off portions 51 and 52 which corresponds to the inclined surface 21s and the step portion 21t of the body portion 21. The knockouts 133 and 134 are disposed inside the knockouts 131 and 132, and have a flat surface that is in contact with a region on the front surface side of the cutting off portions 51 and 52 that corresponds to a flat portion of the body portion 21, the head portion 23, and the neck portion 22. The pressing punch 136 is disposed on the back surface side of the cutting off portions 51 and 52 with the opening portion 50o of the strip plate material 50 that is formed by performing cutting off placed therebetween, is formed by an outer shape that is slightly smaller than the opening portion 50o, and has a flat surface that is inserted through the opening portion 50o and is in contact with a region on the back surface side of the cutting off portions 51 and 52 which corresponds to a part of the body portion 21, the neck portion 22 and the head portion 23.

As shown in FIG. 12, the contact surfaces (pressing surfaces) of the knockouts 131 and 132 have inclined surface forming portions 131s and 132s and step portion forming portions 131b and 132b so that inclined surfaces 51s and 52s and step portions 51b and 52b (see FIG. 14) are formed on the front surfaces of the cutting off portions 51 and 52 (the surfaces on the front surface side of the element 20). The inclined surfaces 51s and 52s each become the inclined surface 21s formed on the front surface of the body portion 21 of each element 20 when the pair of two elements 20 is molded from the cutting off portions 51 and 52. The step portions 51b and 52b each become the step portion 21b formed on the front surface of the body portion 21 of each element 20 when the pair of two elements 20 is molded from the cutting off portions 51 and 52.

As described above, the cutting off portions 51 and 52 are punched so that the pair of two elements 20 is molded in the state in which the top portions 23t of the head portions 23 face each other in the longitudinal direction of the strip plate material 50, and are punched from the surrounding strip plate material 50 so as not to overlap in the plate thickness direction. Thus, as shown in FIG. 12, the material that flows outward (left and right in the figure) when press working (crushing molding) is performed on the cutting off portions 51 and 52 by using the step-crushing molding die 130 does not interfere with the surrounding strip plate material 50. As a result, the inclined surfaces 51s and 52s and the step portions 51b and 52b can be formed on the cutting off portions 51 and 52 with high accuracy. That is, when the pair of two elements 20 is molded from the cutting off portions 51 and 52, the inclined surface 21s and the step portion 21b can be formed on the body portion 21 of each element 20 with high accuracy.

Further, as described above, in the connecting portion 53, the ridge line 53a of the step formed on the back surface side of the cutting off portions 51 and 52 in the preliminary punching step (S2) of the previous step is formed in a straight line shape parallel to the longitudinal direction of the strip plate material 50, and the ridge line 53b of the step formed on the front surface side of the cutting off portions 51 and 52 is formed in an arc shape so as to swell outward in the width direction (short side direction) of the strip plate material 50. Thus, when press working is performed on the cutting off portions 51 and 52 in the step-crushing molding step (S3), as shown in FIG. 15, the material flowing inward can be stopped from flowing to a region in which the pilot holes 50p of the strip plate material 50 are formed via the connecting portion 53, and the displacement and deformation of the pilot holes 50p can be suppressed. Further, the two pilot holes 50p are formed so as to be positioned on a straight line passing through the center between the cutting off portions 51 and 52 and parallel to the width direction of the strip plate material 50. Thus, even if the material flows to the pilot holes 50p when press working is performed on the cutting off portions 51 and 52 in the step-crushing molding step (S3), as shown in FIG. 15, the displacement directions of the pilot holes 50p due to the flow of the material become directions opposite to each other and are canceled. As a result, the displacement of the pilot holes 50p can be suppressed.

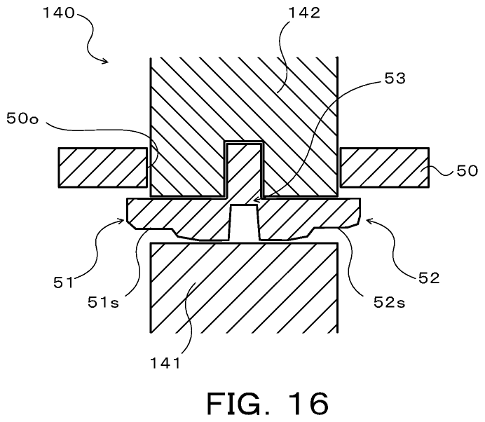

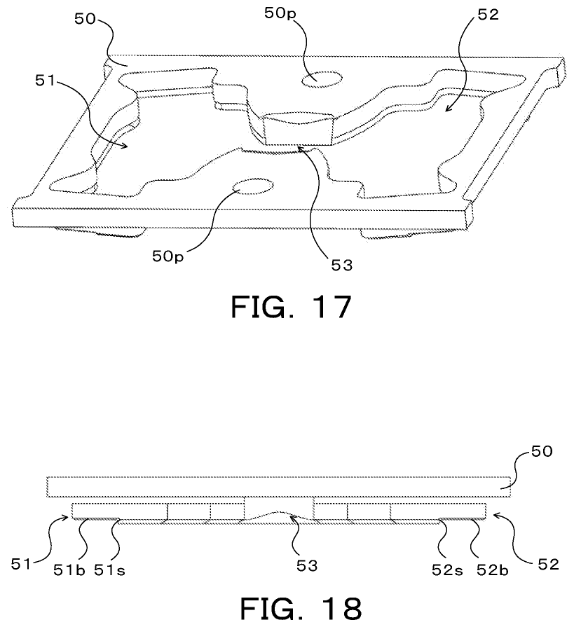

The plate thickness-crushing molding step (S4) is a step in which the plate thickness is adjusted by using the plate thickness-crushing molding die 140 to crush, in the plate thickness direction, the region of each of the cutting off portions 51 and 52 which corresponds to the flat portion of the body portion 21, the neck portion 22, and the head portion 23 of the element 20. FIG. 16 is a schematic configuration view of the plate thickness-crushing molding die. FIG. 17 is an external perspective view of the strip plate material after plate thickness-crushing molding. FIG. 18 is a side view of the strip plate material after the plate thickness-crushing molding. As shown in FIG. 16, the plate thickness-crushing molding die 140 has a knockout 141 that presses the front surfaces of the cutting off portions 51 and 52 (the surfaces on the front surface side of the element 20), and a pressing punch 142 that is disposed so as to face the knockout 141 and that presses down the back surfaces of the cutting off portions 51 and 52 (the surfaces on the back surface side of the element 20).

The pressing punch 142 is disposed on the back surface side of the cutting off portions 51 and 52 with the opening portion 50o of the strip plate material 50 that is formed by performing cutting off placed therebetween, is formed by an outer shape that is slightly smaller than the opening portion 50o, and has a flat surface that is inserted through the opening portion 50o and is in contact with the back surfaces of the cutting off portions 51 and 52. The knockout 141 is formed with substantially the same outer shape as the pressing punch 142, and has a flat surface that is in contact with the front surfaces of the cutting off portions 51 and 52. By compressing the cutting off portions 51 and 52 in the plate thickness direction with the knockout 141 and the pressing punch 142, the plate thickness of the region of each of the cutting off portions 51 and 52 which corresponds to the flat portion of the body portion 21, the neck portion 22, and the head portion 23 of the element 20 can be adjusted, as shown in FIGS. 17 and 18. In the present embodiment, since the plate thickness-crushing molding step (S4) is performed after the step-crushing molding step (S3) so as to be independent from the step-crushing molding step (S3), the plate thickness of the region of each of the cutting off portions 51 and 52 which corresponds to the flat portion of the body portion 21, the neck portion 22, and the head portion 23 can be adjusted with high accuracy.

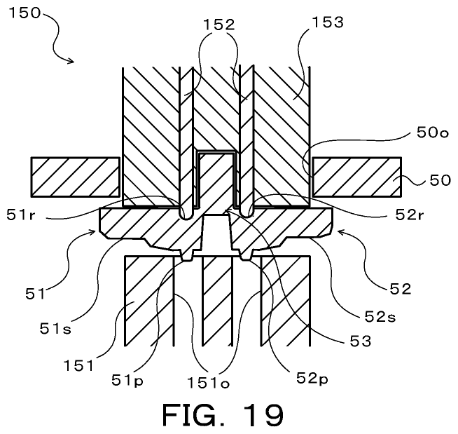

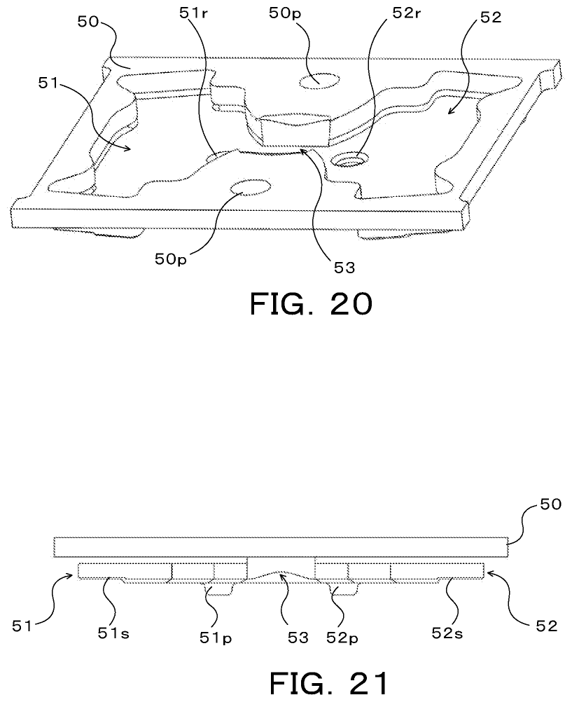

The emboss molding step (S5) is a step of using the emboss molding die 150 to form protrusions 51p and 52p in a region on the front surface side of the cutting off portions 51 and 52 which corresponds to the head portion 23 of the element 20, and to form recesses 51r and 52r on the back surface side of the above region. FIG. 19 is a schematic configuration view of the emboss molding die. FIG. 20 is an external perspective view of the strip plate material after emboss molding. FIG. 21 is a side view of the strip plate material after emboss molding. As shown in FIG. 19, the emboss molding die 150 has: an emboss die 151 having two opening portions 1510 that have a small radius and a cylindrical shape; two emboss punches 152 that are formed in a cylindrical shape with an outer shape slightly smaller than the opening portions 151o, that press the cutting off portions 51 and 52 from the back surface (the surface on the back surface side of the element 20) side, and that press the emboss die 151 against the two opening portions 151o; and a stripper 153 that is disposed around the two emboss punches 152 and that supports the two emboss punches 152.

The stripper 153 is disposed on the back surface side of the cutting off portions 51 and 52 with the opening portion 50o of the strip plate material 50 that is formed by performing cutting off placed therebetween, is formed by an outer shape that is slightly smaller than the opening portion 50o, and has a flat surface that is inserted through the opening portion 50o and is in contact with a region on the back surface side of the cutting off portions 51 and 52 which corresponds to a part of the body portion 21, the neck portion 22, and the head portion 23. The two emboss punches 152 are supported with respect to the stripper 153 so that a tip end portion protrudes from the flat surface of the stripper 153. By performing press working on the cutting off portions 51 and 52 with the emboss die 151 and the emboss punch 152, as shown in FIGS. 20 and 21, the protrusions 51p and 52p are formed on the front surfaces of the cutting off portions 51 and 52, and the recesses 51r and 52r are formed on the back surfaces of the cutting off portions 51 and 52 so as to be positioned on the back side of the protrusions 51p and 52p. The protrusions 51p and 52p each become the protrusion 21p formed on the front surface of the head portion 23 of each element 20 when the pair of two elements 20 is formed from the cutting off portions 51 and 52. Further, the recesses 51r and 52r each become the recess 21r formed on the back surface of the head portion 23 of each element 20 when the pair of two elements 20 is formed from the cutting off portions 51 and 52.

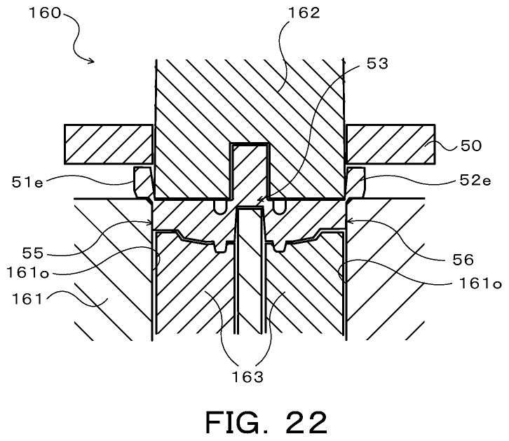

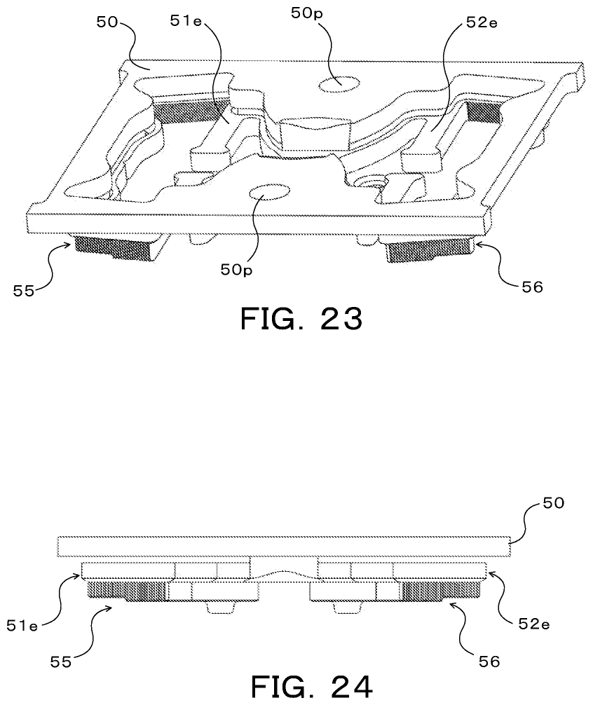

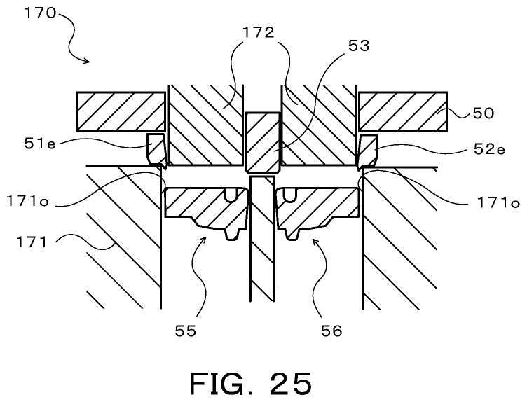

The half-punching step (S6) is a step of using the half-punching die 160 to half-punch the cutting off portions 51 and 52, with the contour line of the outer shape of the pair of two elements 20 excluding the excess thickness portions 51e and 52e from the cutting off portions 51 and 52 serving as a punching line. FIG. 22 is a schematic configuration view of the half-punching die. FIG. 23 is an external perspective view of the strip plate material after half-punching. FIG. 24 is a side view of the strip plate material after half-punching. As shown in FIG. 22, the half-punching die 160 includes a die 161 having two opening portions 161o, a punch 162 that presses the cutting off portions 51 and 52 from the back surface (the surface on the back surface side of the element 20) side against the two opening portions 1610 of the die 161, and two knockouts 163 that are disposed inside the two opening portions 1610 of the die 161 so as to face the punch 162 and that are in contact with the front surfaces of the cutting off portions 51 and 52 (the surface on the front surface side of the element 20).

The two opening portions 1610 of the die 161 are formed so as to have substantially the same inner shape as the outer shape of the pair of two elements 20 in which the top portions 23t of the head portions 23 face each other. The punch 162 is formed with an outer shape having substantially the same shape as the two opening portions 1610 of the die 161, and has a flat surface that is in contact with the back surface (the surface on the back surface side of the element 20) of the cutting off portions 51 and 52. The two knockouts 163 are formed to have substantially the same outer shape as an outer shape of the punch 162 and are disposed inside the two opening portions 1610 so as to face the punch 162, and have a contact surface that is formed so as to follow the shape of the front surface of the cutting off portions 51 and 52 (the surface on the front surface side of the element 20). Since press working is performed on the cutting off portions 51 and 52 with the half-punching die 160, as shown in FIGS. 23 and 24, element molding portions 55 and 56 corresponding to the element 20 are molded in a state in which the element molding portions 55 and 56 are connected to the excess thickness portions 51e and 52e of the cutting off portions 51 and 52 across the entire circumference at the end portions in the plate thickness direction.

The punching out step (S7) is a step of using the punching out die 170 to cut off the element molding portions 55 and 56 and the excess thickness portions 51e and 52e of the cutting off portions 51 and 52. FIG. 25 is a schematic configuration view of the punching out die. As shown in FIG. 25, the punching out die 170 includes a die 171 having two opening portions 171o, and two punches 172 that press the element molding portions 55 and 56 toward the two opening portions 1710 of the die 171. The two opening portions 1710 of the die 171 communicate with a carry-out port that is not shown, and the element molding portions 55 and 56 that have been punched out are carried out from the carry-out port to the outside of the press working machine 105 via the opening portions 171o. Then, the element molding portions 55 and 56 discharged to the outside of the machine are completed as the element 20 after a finishing step such as polishing. In the punching out step (S7), the two element molding portions 55 and 56 are punched out at once by using one punching out die 170. However, the two element molding portions 55 and 56 may be punched out by using two punching out dies in separate steps.

In the above-described embodiment, in the pilot hole punching and slit hole punching step (S1), the slit holes 50s for allowing the flowing material to escape in the preliminary punching step (S2) that is the subsequent step are formed. However, since the amount of the material flowing in the preliminary punching step is small, the slit holes 50s may be omitted.

In the above-described embodiment, the protrusions 51p and 52p and the recesses 51r and 52r (embosses) are formed by performing press working (emboss molding step) once on the cutting off portions 51 and 52. However, the embosses may be molded by performing press working a plurality of times (two times). In this case, the press working to be performed later may be included in the half-punching step and be performed in the same process.

In the above-described embodiment, press working is performed so that the pair of two elements 20 is molded in a state in which the top portions 23t of the head portions 23 face each other in the longitudinal direction of the strip plate material 50. However, press working may be performed so that the pair of two elements 20 is molded in a state in which the top portions 23t of the head portions 23 face each other in the width direction (short side direction) of the strip plate material 50.

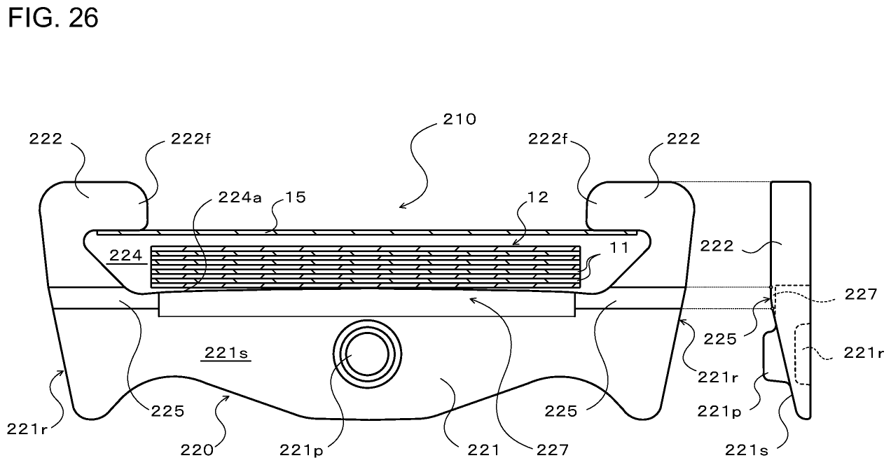

FIG. 26 is a schematic configuration view of a transmission belt including an element of another embodiment. A transmission belt 210 includes one stacked ring 12 configured by stacking a plurality of (in the present embodiment, nine for example) elastically deformable ring materials 11 in a thickness direction (ring radial direction), one retainer ring 15, and a plurality of (for example, several hundred) elements 220 arranged (bound) in an annular shape along an inner peripheral surface of the stacked ring 12.

For example, the retainer ring 15 is elastically deformable and is cut out from a drum made of steel plate, and has a thickness substantially equal to or thinner than that of the ring material 11. Further, the retainer ring 15 has an inner peripheral length longer than an outer peripheral length of the ring material 11 of the outermost layer of the stacked ring 12. As a result, in a state in which the stacked ring 12 and the retainer ring 15 are disposed concentrically (a no-load state in which tension is not applied), as shown in FIG. 26, an annular clearance is formed between the outer peripheral surface of the outermost ring material 11 and the inner peripheral surface of the retainer ring 15.

Each element 220 is punched by press working from the metal strip plate-shaped material (strip plate material) 50 having a uniform plate thickness. As shown in FIG. 26, each element 220 has a body portion 221 extending horizontally in the figure, a pair of pillar portions 222 extending in the same direction from both end portions of the body portion 221, and a single ring housing portion (recessed portion) 224 that is defined between the pair of pillar portions 222 so as to open to a free end side of each pillar portion 222. The pair of pillar portions 222 is extended from both sides in the width direction of a saddle surface 224a that is a bottom surface of the ring housing portion 224 to the outside in the radial direction of the transmission belt 210 (a direction from the inner peripheral side toward the outer peripheral side of the transmission belt 210, that is, upward in the figure). A hook portion 222f protruding in the width direction of the saddle surface 224a is formed on a free end portion of each pillar portion 222. The pair of hook portions 222f face each other at an interval that is slightly longer than the width of the stacked ring 12 (ring material 11) and shorter than the width of the retainer ring 15.

As shown in FIG. 26, the stacked ring 12 is disposed in the ring housing portion 224, and the saddle surface 224a of the ring housing portion 224 is in contact with the inner peripheral surface of the stacked ring 12 (innermost layer ring material 11). The saddle surface 224a has a symmetrical convex curved surface shape (crowning shape) that is gently inclined downward in the figure toward the outside in the width direction with the central portion in the width direction serving as the top portion. As a result, the stacked ring 12 can be centered by applying a centripetal force to the stacked ring 12 toward the top portion by friction with the saddle surface 224a. However, the saddle surface 224a may include a plurality of convex curved surfaces that are curved outward in the radial direction of the stacked ring 12.

Further, the retainer ring 15 is elastically deformed and is fitted into the ring housing portion 224 via the space between the pair of hook portions 222f of each element 220, in a state in which the stacked ring 12 is disposed in the ring housing portions 224 of all the elements 220. Then, the retainer ring 15 is disposed between the outer peripheral surface of the outermost layer ring material 11 of the stacked ring 12 and the hook portions 222f of each element 220 and surrounds the stacked ring 12, and restricts each element 220 from dropping out of the stacked ring 12. As a result, the plurality of elements 220 are bound (arranged) in an annular shape along the inner peripheral surface of the stacked ring 12.

Further, a front surface of the element 220 includes an inclined surface 221s, and a back surface thereof is formed to be flat. That is, a part of the outer peripheral side of the body portion 221 (the outer side in the radial direction of the transmission belt 210, etc.) and the pillar portions 222 have a substantially constant thickness, and the inclined surface 221s is formed on the body portion 221, in which the inclined surface 221s approaches the back surface as extending from a position more toward the inner peripheral side (the inner side in the radial direction of the transmission belt 210, etc.) than the saddle surface 224a, further toward the inner peripheral side. An edge portion on an outer peripheral side of the inclined surface 221s (a boundary part in which the thickness of the element 220 changes) forms a rocking edge 225 that brings the elements 220 adjacent in a traveling direction of the transmission belt 10 into contact with each other and that serves as a fulcrum of rotation of the elements 220. Thus, the rocking edge 225 is positioned on an inner peripheral side of each saddle surface 224a. Further, one protrusion (dimple) 221p is formed in the central portion in the width direction of a front surface (one surface) of the body portion 221, and a recess 211r is formed on a back surface (the other surface) of the body portion 221 so as to be positioned on the back side of the protrusion 221p. Further, the body portion 221 of each element 220 has a pair of side surfaces 221f that is formed so as to be spaced away from each other, from the inner peripheral side toward the outer peripheral side (the outer side in the radial direction of the transmission belt 210, etc.) of the transmission belt 210, etc., and that functions as flank surfaces.

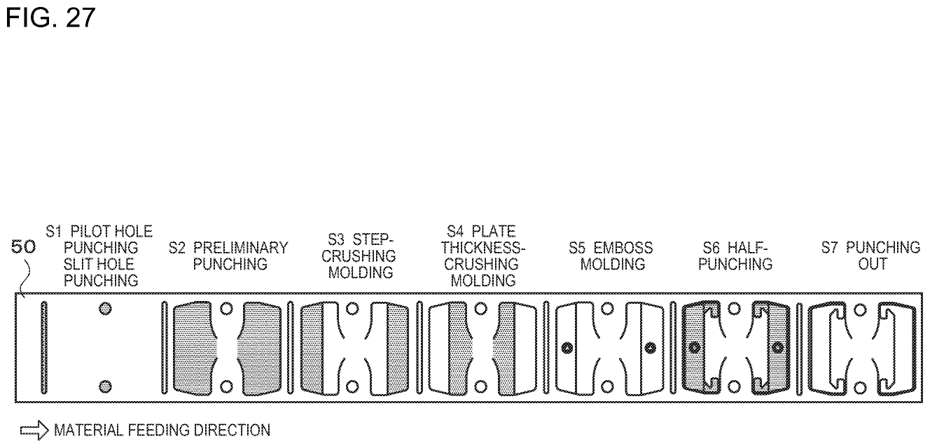

The element 220 configured in this way can be manufactured by punching the strip plate material 50 using a feeding press working machine, similar to the element 20 of the present embodiment. That is, the element 220 is manufactured by feeding the strip plate material 50 to each press position of the press working machine and performing press working with respect to the strip plate material 50 at each press position. As shown in FIG. 27, similar to the press working step of the element 20, the press working step performed on the element 220 includes the pilot hole punching and slit hole punching step (S1), the preliminary punching step (S2), the step-crushing molding step (S3), the plate thickness-crushing molding step (S4), the emboss molding step (S5), the half-punching step (S6), and the punching out step (S7). The press working in each step can be performed by performing punching so that the pair of two elements 220 is molded in a state in which the free end sides of the pillar portions 222 face each other in the longitudinal direction of the strip plate material 50.

As described above, an outline of the element manufacturing method of the present disclosure is that the element manufacturing method is for manufacturing an element (20) that constitutes a transmission belt (10) wound between a pair of pulleys (3, 5) of a continuously variable transmission (1) and that has a thick wall portion (22, 23) and a thin wall portion (21s, 21b), by sequentially feeding a material (50) having a strip shape with a uniform thickness to each press position and performing press working on the material (50) at the press position, in which as the press working performed at the press position, the element manufacturing method includes: a preliminary punching step (S2) in which a cutting off portion (51, 52) other than a connecting portion (53) is cut off from a surrounding material (50) while the connecting portion (53) connected to the surrounding material (50) is left, and the cutting off portion (51, 52) is punched so as not to overlap with the surrounding material (50) in a plate thickness direction; a crushing step (S3) of compressing and crushing a region of the cutting off portion (51, 52) which corresponds to the thin wall portion (21s, 21b), after the preliminary punching step (S2); and a punching step (S6 to S8) of punching the cutting off portion (51, 52) into an outer shape corresponding to the element (20), after the crushing step (S3).

The element manufacturing method of the present disclosure manufactures an element that constitutes a transmission belt of a continuously variable transmission and that has a thick wall portion and a thin wall portion, by sequentially feeding a material having a strip shape with a uniform thickness to each press position and performing press working on the material at the press position. As the press working performed at the press position, the element manufacturing method includes: a preliminary punching step in which a cutting off portion other than a connecting portion is cut off from a surrounding material while the connecting portion connected to the surrounding material is left, and the cutting off portion is punched so as not to overlap with the surrounding material in a plate thickness direction; a crushing step of compressing and crushing a region of the cutting off portion which corresponds to the thin wall portion, after the preliminary punching step; and a punching step of punching the cutting off portion into an outer shape corresponding to the element, after the crushing step. In this way, since the cutting off portion is punched out so as not to overlap with the surrounding material in the plate thickness direction, and then the cutting off portion is compressed and crushed, the compressed material can smoothly flow in a plane direction. As a result, when the element is molded, the thin wall portion can be formed with high accuracy. In addition, this makes it possible to eliminate the need to form slits around the material in advance in order to secure the flow destination of the material in the crushing process, and to make the required slits smaller. Thus, the element can be taken out more efficiently from the material and the product yield can be improved. As a result, when the element having the thick wall portion and the thin wall portion is molded from the strip plate shaped material having a uniform thickness by performing punching work, the product yield can be improved while accurately molding the thin wall portion. When a pilot hole forming step in which a pilot hole for positioning the material in the subsequent step is formed in the material is provided before the preliminary punching step, since the cutting off portion and the surrounding material are displaced in the plate thickness direction, it is possible to suppress the material compressed by the crushing process from flowing toward the pilot hole to cause an adverse effect on the pilot hole.

In such an element manufacturing method of the present disclosure, the element (20) may have a side surface portion (210 that is in contact with the pulleys (3, 5) on both sides in a width direction, and the thin wall portion (21s, 21r) on an inner peripheral side in a radial direction of the transmission belt (10) that is orthogonal to the width direction, press working may be performed so that a pair of two elements (20) is molded in a state in which end portions (23) on an outer peripheral side in the radial direction face each other, the manufacturing method may be provided with a pilot hole forming step (S1) of forming a pilot hole (50p) for positioning the material (50) in a subsequent step (S5) such that the pilot hole (50p) is positioned on a straight line that passes through a center between the end portions (23) of the material (50) and that is parallel to the width direction, before the preliminary punching step (S2), and the preliminary punching step (S2) may form the connecting portion (53) at a position corresponding to a position between the end portions (23). In this way, when the region corresponding to the inner peripheral side in the radial direction of the cutting off portion is compressed in the crushing process, even if the compressed material flows to the outer peripheral side in the radial direction and heads toward the pilot holes through the connecting portion, the displacement directions of the pilot holes due to the flow of the material become opposite to each other and are canceled. As a result, the displacement of the pilot holes can be suppressed. In this case, the element (20) may have a body portion (21) including the side surface portion (210 and the thin wall portion (21s, 21b), a head portion (23), and a neck portion (22) that extends in the radial direction from a central portion in the width direction of the body portion (21) and that couples the body portion (21) and the head portion (23), press working may be performed so that the pair of two elements (20) is molded in a state in which top portions (23t) of the head portions (23) face each other, and the preliminary punching step (S2) may form the connecting portion (53) at a position corresponding to the top portions (23t) of the head portions (23).

Further, in the element manufacturing method that includes a pilot hole forming step, in the preliminary punching step (S2), when molding the connecting portion (53), press working may be performed so that a ridge line (53b) of a step has a curved shape, in which the step is generated in the plate thickness direction with respect to the surrounding material (50) on the same side as a surface in which the cutting off portion (51, 52) is compressed by the subsequent crushing step (S3). As a result, a range of the cutting off portion can be widened while sufficiently ensuring the strength of the connecting portion (the coupling strength of the cutting off portion and the surrounding material). In addition, when press working is performed on the cutting off portion in the crushing process, it is possible to prevent the material from flowing to the region of the material in which the pilot hole is formed via the connecting portion, and it is possible to suppress the displacement and deformation of the pilot hole. Here, the ridge line (53b) of the step generated in the plate thickness direction with respect to the surrounding material on the same side as the surface on which the cutting off portion is compressed may be a convex curve bulging to the outer side in the width direction of the material. Further, a ridge line (53a) of the step generated in the plate thickness direction with respect to the surrounding material on the side opposite to the surface on which the cutting off portion is compressed may have a linear shape.

Further, the element manufacturing method may be provided with a plate thickness adjusting step (S4) of compressing a region of the cutting off portion (51, 52) which corresponds to the thick wall portion (22, 23) to adjust the plate thickness, after the crushing step (S3). By providing the plate thickness adjusting process separately from the crushing process, it is possible to accurately adjust the plate thickness of the thick wall portion.

An outline of the element manufacturing device of the present disclosure is that the element manufacturing device is for manufacturing an element (20) that constitutes a transmission belt (10) wound between a pair of pulleys (3, 5) of a continuously variable transmission (1) and that has a thick wall portion (22, 23) and a thin wall portion (21s, 21b), by sequentially feeding a material (50) having a strip shape with a uniform thickness to each press position and performing press working on the material (50) at the press position. The element manufacturing device includes: a preliminary punching die (120) that is provided at a first press position and that performs preliminary punching in which a cutting off portion (51, 52) other than a connecting portion (53) is cut off from a surrounding material (50) while the connecting portion (53) connected to the surrounding material (50) is left, and the cutting off portion (51, 52) is punched so as not to overlap with the surrounding material (50) in a plate thickness direction; a crushing die (130) that is provided at a second press position downstream of the first press position in a feeding direction and that performs crushing work in which a region of the cutting off portion (53) that becomes the thin wall portion (21s, 21r) is compressed; and a punching die (160, 170) that is provided at a third press position downstream of the second press position in the feeding direction and that performs punching work in which the connecting portion (53) and the cutting off portion (51, 52) are punched into an outer shape corresponding to the element (20).

The element manufacturing device of the present disclosure is provided with the dies (the preliminary punching die, the crushing die, and the punching die) for performing press working to realize each step of the above-described element manufacturing method of the present disclosure. Thus, an effect similar to the effect delivered by the element manufacturing method of the present disclosure can be delivered by the element manufacturing device. That is, when an element having a thick wall portion and a thin wall portion is molded from a strip plate shaped material having a uniform thickness by performing punching work, an effect of improving product yield while accurately molding the thin wall portion can be delivered.

Although the embodiments of the present disclosure have been described above, the present disclosure is not limited to these embodiments, and it goes without saying that the present disclosure can be implemented in various forms without departing from the gist of the present disclosure.

### INDUSTRIAL APPLICABILITY

The present disclosure can be used in the element manufacturing industry.

1. An element manufacturing method for manufacturing an element that constitutes a transmission belt wound between a pair of pulleys of a continuously variable transmission and that has a thick wall portion and a thin wall portion, by sequentially feeding a material having a strip shape with a uniform thickness to each press position and performing press working on the material at the press position, wherein
as the press working performed at the press position, the element manufacturing method includes:
a preliminary punching step in which a cutting off portion other than a connecting portion is cut off from a surrounding material while the connecting portion connected to the surrounding material is left, and the cutting off portion is punched so as not to overlap with the surrounding material in a plate thickness direction;
a crushing step of compressing and crushing a region of the cutting off portion which corresponds to the thin wall portion, after the preliminary punching step; and
a punching step of punching the cutting off portion into an outer shape corresponding to the element, after the crushing step.

2. The element manufacturing method according to claim 1, wherein
the element has a side surface portion that is in contact with the pulleys on both sides in a width direction, and the thin wall portion on an inner peripheral side in a radial direction of the transmission belt that is orthogonal to the width direction,
press working is performed so that a pair of two elements is molded in a state in which end portions on an outer peripheral side in the radial direction face each other,
the manufacturing method is provided with a pilot hole forming step of forming a pilot hole for positioning the material in a subsequent step such that the pilot hole is positioned on a straight line that passes through a center between the end portions of the material and that is parallel to the width direction, before the preliminary punching step, and
the preliminary punching step forms the connecting portion at a position corresponding to a position between the end portions.

3. The element manufacturing method according to claim 2, wherein
the element has a body portion including the side surface portion and the thin wall portion, a head portion, and a neck portion that extends in the radial direction from a central portion in the width direction of the body portion and that couples the body portion and the head portion,
press working is performed so that the pair of two elements is molded in a state in which top portions of the head portions face each other, and
the preliminary punching step forms the connecting portion at a position corresponding to the top portions of the head portions.

4. The element manufacturing method according to claim 2, wherein in the preliminary punching step, when molding the connecting portion, press working is performed so that a ridge line of a step has a curved shape, in which the step is generated in the plate thickness direction with respect to the surrounding material on the same side as a surface in which the cutting off portion is compressed by the crushing step.

5. The element manufacturing method according to claim 1, wherein the element manufacturing method is provided with a plate thickness adjusting step of compressing a region of the cutting off portion that becomes the thick wall portion to adjust the plate thickness, after the crushing step.

6. An element manufacturing device for manufacturing an element that constitutes a transmission belt of a continuously variable transmission and that has a thick wall portion and a thin wall portion, by sequentially feeding a material having a strip shape with a uniform thickness to each press position and performing press working on the material at the press position, the element manufacturing device comprising:
a preliminary punching die that is provided at a first press position and that performs preliminary punching in which a cutting off portion other than a connecting portion is cut off from a surrounding material while the connecting portion connected to the surrounding material is left, and the cutting off portion is punched so as not to overlap with the surrounding material in a plate thickness direction;
a crushing die that is provided at a second press position downstream of the first press position in a feeding direction and that performs crushing work in which a region of the cutting off portion which corresponds to the thin wall portion is compressed; and
a punching die that is provided at a third press position downstream of the second press position in the feeding direction and that performs punching work in which the cutting off portion is punched into an outer shape corresponding to the element.
